(19) United States
(12) Patent Application Publication
(10) Pub. No.: US 2007/0135062 A1
(43) Pub. Date: Jun. 14, 2007

(54) Apparatus for automatically matching frequency of antenna in wireless terminal and method thereof

(75) Inventors: In-Jin Hwang, Gumi-si (KR); Jae-Ho Lee, Gumi-si (KR); Young-Hwan Kim, Dalseo-gu (KR); Yeong-Moo Ryu, Gumi-si (KR); Hark-Sang Kim, Buk-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/442,312

(22) Filed: May 30, 2006

(30) Foreign Application Priority Data
Dec. 14, 2005 (KR) 10-2005-0123492
Mar. 22, 2006 (KR) 10-2006-0026132

(51) Int. Cl. H04B 1/46; H04B 1/04; H01Q 11/12

(52) U.S. Cl. 455/80; 455/121

(57) ABSTRACT

An apparatus and method for automatically matching an impedance for a frequency of an antenna in a wireless terminal. The apparatus automatically matches an impedance for a frequency of an antenna in a wireless terminal. The apparatus includes a duplexer for classifying frequencies transmitted/received through the antenna of the wireless terminal, an automatic matching module for transmitting the reception frequency, which is received from the duplexer, to an amplifier after automatically matching impedance for the reception frequency and for transmitting the transmission frequency, which is received from the amplifier, to the duplexer after automatically matching impedance for the transmission frequency, and a controller for controlling the automatic matching module to automatically match impedance for the transmission/reception frequency.

### CROSS-REFERENCE TO RELATED APPLICATIONS

This application claims the benefit under 35 U.S.C. §119(a) of Korean Patent Application Nos. 10-2005-0123492, entitled “Apparatus for Automatically Matching An Impedance for A Frequency of Antenna in Wireless Terminal”, filed in the Korean Intellectual Property Office on Dec. 14, 2005, and 10-2006-0026132, also entitled “Apparatus for Automatically Matching An Impedance for A Frequency of Antenna in Wireless Terminal”, filed in the Korean Intellectual Property Office on Mar. 22, 2006, the entire disclosures of both are incorporated herein by reference.

### BACKGROUND OF THE INVENTION

1. Field of the Invention

The present invention relates to an apparatus for automatically matching a frequency of an antenna in a wireless terminal. More particularly, the present invention relates to an apparatus for automatically matching an impedance for a frequency of an antenna in a wireless terminal.

2. Description of the Related Art

Conventionally, if a user holds a wireless terminal in the user's hand, there occurs a phenomenon in which impedance matching for an antenna of the wireless terminal is not achieved. When a user of a wireless terminal does not use the wireless terminal, that is, when the user does not hold the wireless terminal in the user's hand, an impedance of the antenna in the wireless terminal is matched. However, if the user holds the wireless terminal in order to use the wireless terminal, the impedance matching for the antenna in the wireless terminal is not achieved, so performance of the wireless terminal is degraded.

Accordingly, a need exists for a system and method for automatically matching an impedance for a frequency of an antenna in a wireless terminal.

### SUMMARY OF THE INVENTION

Accordingly, embodiments of the present invention have been made to substantially solve the above-mentioned and other problems occurring in the prior art, and an object of embodiments of the present invention is to provide an apparatus for automatically matching an impedance for a frequency of an antenna in a wireless terminal.

To accomplish the above and other objects, an apparatus is provided for automatically matching impedance for a frequency of an antenna in a wireless terminal, the apparatus comprising a duplexer for classifying frequencies transmitted/received through the antenna of the wireless terminal, transmitting a reception frequency, which is received from the antenna, to an automatic matching module, and transmitting a transmission frequency, which is received from the automatic matching module, to the antenna, the automatic matching module for transmitting the reception frequency, which is received from the duplexer, to an amplifier after automatically matching impedance for the reception frequency and for transmitting the transmission frequency, which is received from the amplifier, to the duplexer after automatically matching impedance for the transmission frequency, and a controller for controlling the automatic matching module to automatically match impedance for the transmission/reception frequency.

According to another aspect of embodiments of the present invention, an apparatus is provided for automatically matching impedance for a frequency of an antenna in a wireless terminal receiving at least two communication services, the apparatus comprising a switching module for switching to one of the at least two communication service modules according to a signal received in an antenna of the wireless terminal, and at least two communication service modules for outputting a reception frequency, which is received through the antenna, by automatically matching an impedance for the reception frequency, or transmitting a transmission frequency to the antenna by automatically impedance matching the transmission frequency when the communication service modules are linked with the antenna through switching action of the switching module.

According to still another aspect of embodiments of the present invention, an apparatus is provided for automatically matching impedance for an antenna frequency in a wireless terminal, the apparatus comprising a signal detection module for detecting a signal received from an antenna of the wireless terminal, a controller for determining a state of the wireless terminal according to a signal output from the signal detection module and controlling an automatic matching module to automatically match an impedance for a transmission/reception frequency of the antenna, the automatic matching module for transmitting the reception frequency, which is received from the antenna, to a duplexer after automatically matching an impedance for the reception frequency, or transmitting the transmission frequency, which is received from the duplexer, to the antenna after automatically matching an impedance for the transmission frequency, and the duplexer for classifying frequencies transmitted/received through the automatic matching module and transmitting the reception frequency, which is received from the automatic matching module, to the amplifier, or transmitting the transmission frequency, which is received from the amplifier, to the automatic matching module.

According to still another aspect of embodiments of the present invention, an apparatus is provided for automatically matching an impedance for an antenna frequency in a wireless terminal, which receives at least two communication services, the apparatus comprising a signal detection module for detecting a signal received from an antenna of the wireless terminal, a controller for determining a state of the wireless terminal according to a signal output from the signal detection module and controlling an automatic matching module to automatically match an impedance for a transmission/reception frequency of the antenna, the automatic matching module for transmitting the reception frequency which is received from the antenna, to a switching module after automatically matching an impedance for the reception frequency received from the antenna, or for transmitting a transmission frequency, which is received from the switching module, to the antenna after automatically matching an impedance for the transmission frequency, the switching module which is switched to any one of at least two communication service modules according to a type of a reception signal received in the antenna, and at least two communication service modules for transmitting/receiving a frequency of the antenna through the automatic matching module if the at least two communication service modules are linked with the automatic matching module through switching action of the switching module.

### BRIEF DESCRIPTION OF THE DRAWINGS

The above and other objects, features and advantages of embodiments of the present invention will become more apparent from the following detailed description taken in conjunction with the accompanying drawings, in which:

FIG. 1 is a block diagram illustrating a structure of an exemplary apparatus for automatically matching an impedance for a frequency of an antenna in a wireless terminal according to a first embodiment of the present invention;

FIG. 2 is a block diagram illustrating a structure of another exemplary apparatus for automatically matching an impedance for a frequency of an antenna in a wireless terminal receiving at least two communication services according to the first embodiment of the present invention;

FIG. 3 is a block diagram illustrating a structure of an exemplary apparatus for automatically matching an impedance for a frequency of an antenna in a wireless terminal according to a second embodiment of the present invention;

FIG. 4 is a block diagram illustrating a structure of another exemplary apparatus for automatically matching an impedance for a frequency of an antenna in a wireless terminal receiving at least two communication services according to the second embodiment of the present invention;

FIG. 5 is a circuit diagram illustrating the structure of an exemplary capacitor bank in an automatic matching module according to an embodiment of the present invention; and

FIGS. 6A to 6C are views for explaining automatic impedance matching for a frequency of an antenna in a wireless terminal according to embodiments of the present invention.

Throughout the drawings, like reference numerals will be understood to refer to like parts, components and structures.

### DETAILED DESCRIPTION OF THE EXEMPLARY EMBODIMENTS

Hereinafter, exemplary embodiments of the present invention will be described in detail with reference to the accompanying drawings. Same or similar components in the drawings are designated by the same reference numerals even when shown in different drawings. In the following description of embodiments of the present invention, a detailed description of known functions and configurations incorporated herein is omitted for clarity and conciseness.

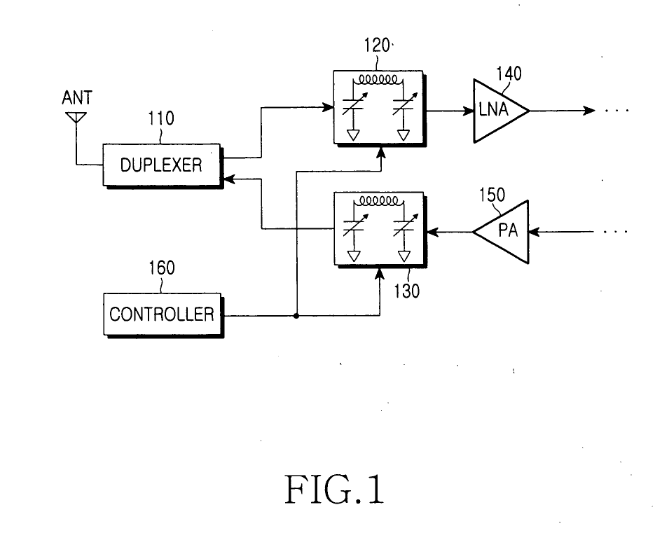

FIG. 1 is a block diagram illustrating the structure of an exemplary apparatus for automatically matching an impedance for a frequency of an antenna in a wireless terminal according to a first embodiment of the present invention. The apparatus comprises an antenna ANT, a duplexer 110, a first automatic matching module 120, a second automatic matching module 130, a first amplifier 140, and a second amplifier 150. The apparatus can further comprise a controller 160.

The duplexer 110 is divided into a transmission port and a reception port in cooperation with the antenna ANT of the wireless terminal, and transmits a reception frequency received therein from the antenna to the first automatic matching module 120 through the reception port. In addition, the duplexer 110 transmits a transmission frequency received from the second automatic matching module 130 to the antenna ANT through the transmission port.

The controller 160 controls the overall operation of the wireless terminal. According to the first exemplary embodiment of the present invention, the controller 160 controls an automatic matching module based on a predetermined optimum frequency signal value of the antenna ANT, thereby automatically matching an impedance for a frequency of the antenna ANT.

The automatic matching module, which automatically matches the impedance for a frequency of an antenna, comprises the first automatic matching module 120 and the second automatic matching module 130, but is not limited thereto.

The first automatic matching module 120 comprises a fixed inductor and variable capacitors in order to automatically match the impedance for the reception frequency output from the reception port of the duplexer 110 by adjusting the values of the capacitors, and then transmit the reception frequency to the first amplifier 140. The second automatic matching module 130 comprises a fixed inductor and variable capacitors in order to automatically match the impedance for the transmission frequency, which is amplified and output in the second amplifier 150, by adjusting the value of the capacitors, and then transmit the transmission frequency to the duplexer 110.

The first and second automatic matching modules 120 and 130 comprise at least one capacitor bank, and the capacitor bank has a structure in which n capacitors are linked with each other.

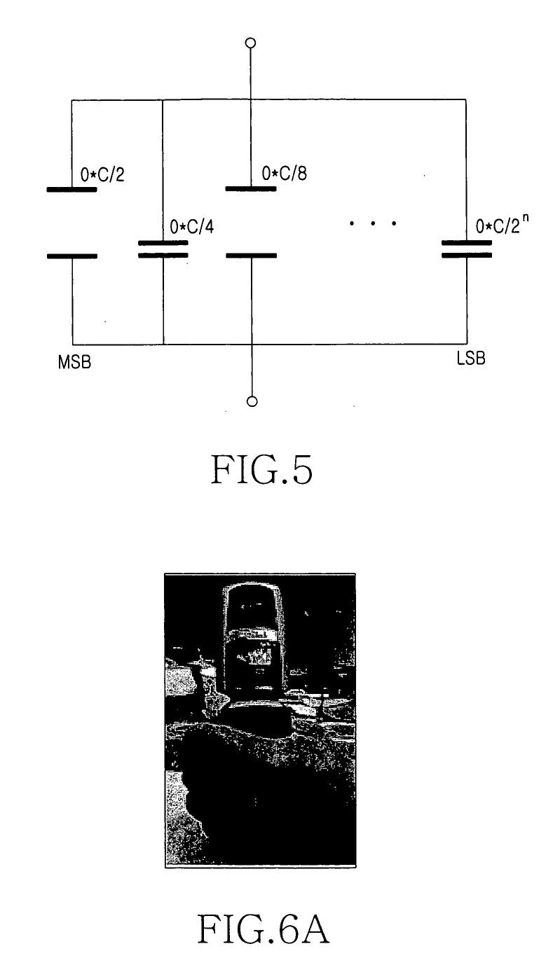

FIG. 5 shows an exemplary capacitor bank having n capacitors linked with each other. Values of the capacitors (Cs) included in the capacitor bank may sequentially increase as C/2, C/4, C/8, . . . , and C/2ⁿ. The capacitors are linked through a switch and have values of “1” and “0” according to an on and off state thereof. In addition, the total capacitance value Cₜₒₜₐₗ of the capacitors equals “0*C/2+1*C/4+0*C/8+ . . . +1*C/2ⁿ”.

The first exemplary embodiment of the present invention will be described on the assumption for example, that the first and second automatic matching modules 120 and 130 comprise four capacitor banks, in which each capacitor bank comprises eight capacitors linked with each other. Thus, one capacitor bank according to the first exemplary embodiment of the present invention may have 2⁸ (i.e., 256) capacitor values.

Therefore, the first automatic matching module 120 performs on/off operations for corresponding capacitors under the control of the controller 160 by extracting capacitor values suitable for forming an optimum reception frequency signal from a plurality of capacitor values of the four capacitor banks, thereby automatically matching the impedance for the reception frequency. In addition, the second automatic matching module 130 performs on/off operations for corresponding capacitors under the control of the controller 160 by extracting capacitor values suitable for forming an optimum transmission frequency signal from a plurality of capacitor values of the four capacitor banks, thereby automatically matching the impedance for the transmission frequency.

An amplifier module, which amplifies a frequency signal transmitted/received through the antenna ANT, comprises the first amplifier 140 and the second amplifier 150. The first amplifier 140 amplifies and outputs the reception frequency, which is output from the first automatic matching module 120 after impedance matching. In this case, the first amplifier 140 may comprise a low noise amplifier (LNA), but is not limited thereto. In addition, the second amplifier 150 amplifies the transmission frequency so as to output the transmission frequency to the second automatic matching module 130. In this case, the second amplifier 150 may comprise a power amplifier (PA), but is not limited thereto.

Hereinafter, an exemplary procedure for automatically matching the impedance for a frequency of an antenna in a wireless terminal having the exemplary structure shown in FIG. 1 will be described. When a signal is received through the antenna ANT of the wireless terminal, the controller 160 detects this and outputs a reception frequency signal, which has been received from the antenna ANT through the reception port of the duplexer 110, to the first automatic matching module 120. The first automatic matching module 120 performs on/off operations for corresponding capacitors under the control of the controller 160 by extracting capacitor values suitable for forming an optimum reception frequency signal from a plurality of capacitor values, thereby automatically performing impedance matching for the reception frequency, and then transmits the reception frequency to the first amplifier 140. Then, the controller 160 controls the reception frequency signal, which is output from the first automatic matching module 120 with impedance matching, such that the reception frequency signal is output after being amplified through the first amplifier 140.

In addition, when a transmission frequency signal is generated in the wireless terminal, the controller 160 detects this, amplifies the transmission frequency signal through the second amplifier 150, and then outputs the transmission frequency signal to the second automatic matching module 130.

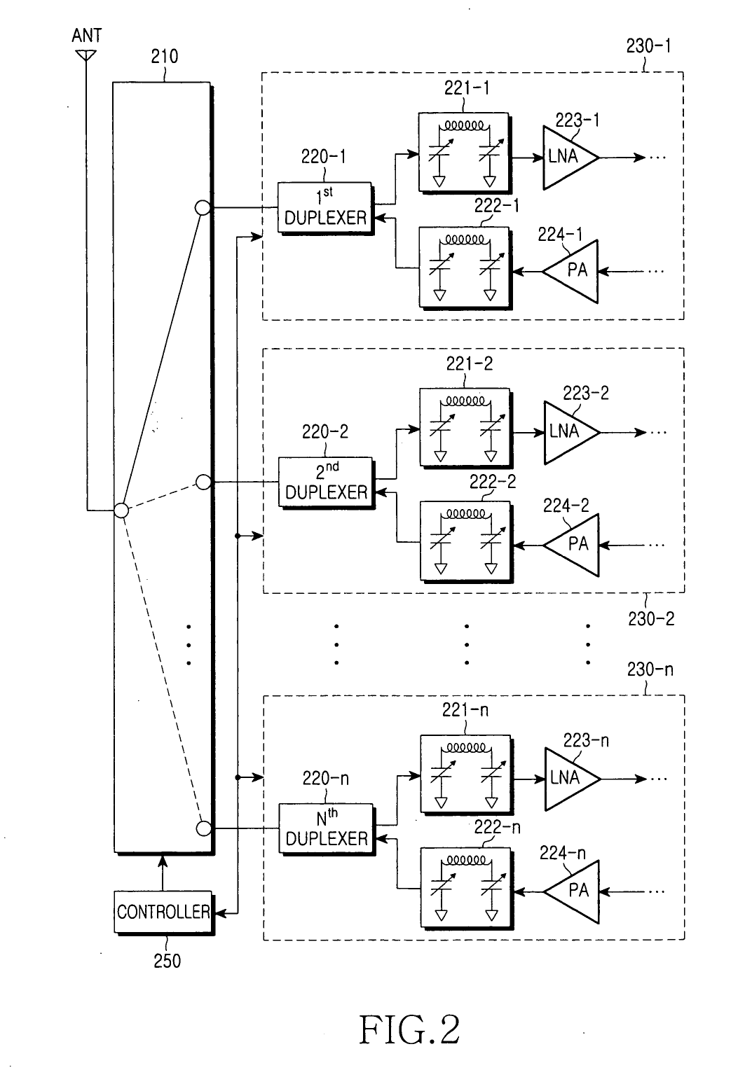

The second automatic matching module 130 performs on/off operations for corresponding capacitors under the control of the controller 160 by extracting capacitor values suitable for forming an optimum transmission frequency signal from among a plurality of capacitor values, thereby automatically performing impedance matching for the transmission frequency, and then transmits the transmission frequency to the duplexer 110. Then, the controller 160 transmits the transmission frequency signal, which has been output from the second automatic matching module 130 with impedance matching, to the antenna ANT through the transmission port of the duplexer 110. FIG. 2 is a block diagram illustrating a structure of another exemplary apparatus for automatically matching an impedance for a frequency of an antenna in a wireless terminal for receiving at least two communication services according to the first embodiment of the present invention. The wireless terminal can perform at least two communication services.

In the exemplary apparatus of FIG. 2, a controller 250 is provided and controls the operation of the wireless terminal. The controller 250 controls a switching module 210 to be switched to one of two or more communication services according to a type of a reception signal received in the antenna ANT. In addition, the controller 250 controls automatic matching modules, which are included in two or more communication service modules, so as to automatically perform impedance matching for an antenna frequency according to a preset optimum antenna frequency signal value.

The switching module 210 is switched to one of the communication service modules 230-1 to 230-n according to the type of a reception signal received in the antenna ANT of the wireless terminal under the control of the controller 250, such that a communication service corresponding to the communication module can be realized.

The two or more communication service modules 230-1 to 230-n perform communication services such as a CDMA service, PCS service, and GSM service, but are not limited thereto. Each of the communication service modules 230-1 to 230-n comprises a duplexer, an automatic matching module, and an amplifier. In addition, the two or more communication service modules 230-1 to 230-n may comprise mobile Internet services, such as wireless LAN or WiBro, in addition to the CDMA, PCS, and GSM services.

Hereinafter, a description will be made in relation to the first communication service module 230-1, but is also applicable to the remaining service modules. The first communication service module 230-1 comprises a first duplexer 220-1, a first automatic matching module 221-1, a second automatic matching module 222-1, a first amplifier 223-1, and a second amplifier 224-1. As the first duplexer 220-1 is linked with the antenna ANT through the switching module 210, the first duplexer 220-1 is divided into a transmission port and a reception port in cooperation with the antenna ANT. In addition, the first duplexer 220-1 transmits a reception frequency received from the antenna ANT to the first automatic matching module 221-1 through the reception port. In addition, the first duplexer 220-1 transmits a transmission frequency received from the second automatic matching module 222-1 to the antenna ANT through the transmission port.

An automatic matching module, which automatically matches the impedance for a frequency of an antenna, comprises the first automatic matching module 221-1 and the second automatic matching module 222-1. The first automatic matching module 221-1 comprises a fixed inductor and variable capacitors in order to automatically match the impedance for a received frequency output from the reception port of the first duplexer 220-1, and then transmit the received frequency to the first amplifier 223-1. In addition, the second automatic matching module 222-1 comprises a fixed inductor and variable capacitors in order to automatically match the impedance for a transmission frequency, which is amplified and output in the second amplifier 224-1, and then transmit the transmission frequency to the first duplexer 220-1.

The first and second automatic matching modules 221-1 and 222-1 comprise at least one capacitor bank, respectively. The capacitor bank comprises n capacitors, which are linked with each other as shown in FIG. 5. In addition, the first and second automatic matching modules 221-1 and 222-1 comprise four capacitor banks as in FIG. 1, in which each capacitor bank may comprise eight capacitors (Cs) linked with each other.

Therefore, the first automatic matching module 221-1 performs on/off operations for corresponding capacitors under the control of the controller 250 by extracting capacitor values suitable for forming an optimum reception frequency signal from a plurality of capacitor (C) values of the four capacitor banks, thereby automatically matching the impedance for the reception frequency. The second automatic matching module 222-1 performs on/off operations for corresponding capacitors under the control of the controller 250 by extracting capacitor values suitable for forming an optimum transmission frequency signal from a plurality of capacitor (C) values of the four capacitor banks, thereby automatically matching the impedance for the transmission frequency.

An amplifier module, which amplifies a transmission/reception frequency signal transmitted/received through the antenna, comprises the first amplifier 223-1 and the second amplifier 224-1. The first amplifier 223-1 amplifies and outputs the reception frequency, which has undergone impedance matching and output in the first automatic matching module 221-1. In this case, the first amplifier 223-1 may comprise a low noise amplifier (LNA), but is not limited thereto. In addition, the second amplifier 224-1 amplifies the transmission frequency so as to output the transmission frequency to the second automatic matching module 222-1. In this case, the second amplifier 224-1 may comprise a power amplifier (PA), but is not limited thereto.

The second duplexer 220-2 to the n^{th} duplexer 220-n, automatic matching modules 221-2 to 221-n and 222-2 to 222-n, and amplifiers 223-2 to 223-n and 224-2 to 224-n included in the second communication service module 230-2 to the n^{th} communication service module 230-n, respectively, in addition to the first communication service module 230-1, perform corresponding communication service functions while performing substantially the same functions as the first duplexer 220-1, the automatic matching modules 221-1 and 222-1, and the amplifiers 223-1 and 224-1 included in the first communication service module 230-1.

Hereinafter, an exemplary operation for automatically matching impedance for a frequency of an antenna in a wireless terminal including the exemplary structure shown in FIG. 2 will be described. If a frequency signal for a communication service, which can be performed by the first communication service module 230-1, such as a CDMA communication service is received in the wireless terminal capable of performing two or more communication services, the controller 250 of the wireless terminal detects this and controls the switching module 210 to switch to an appropriate communication service module, for example, the first communication service module 230-1. If the switching module 210 switches to the first communication service module 230-1, the controller 250 detects this and outputs the reception frequency signal, which has been received from the antenna ANT, to the first automatic matching module 221-1 through the reception port of the first duplexer 220-1. The first automatic matching module 221-1 performs on/off operations for corresponding capacitors under the control of the controller 250 by extracting capacitor values suitable for forming an optimum reception frequency signal from a plurality of capacitor (C) values of the four capacitor banks, thereby automatically performing impedance matching for the reception frequency, and then transmits the reception frequency to the first amplifier 223-1. Then, the controller 250 outputs the reception frequency signal, which has been output from the first automatic matching module 221-1 with impedance matching, after amplifying the reception frequency signal through the first amplifier 223-1.

In addition, when a transmission frequency signal is generated in a CDMA communication service, the controller 250 detects this, amplifies the transmission frequency signal through the second amplifier 224-1, and then outputs the transmission frequency signal to the second automatic matching module 222-1. The second automatic matching module 222-1 performs on/off operations for corresponding capacitors under the control of the controller 250 by extracting capacitor values suitable for forming an optimum reception frequency signal from a plurality of capacitor (C) values, thereby automatically matching the impedance for the transmission frequency, and then transmits the transmission frequency to the first duplexer 220-1. Then, the controller 250 transmits the transmission frequency, which has been output from the second automatic matching module 222-1 with impedance matching, to the antenna through the transmission port of the first duplexer 220-1.

Impedance matching for an antenna frequency can be automatically achieved based on an optimum frequency signal value by means of the exemplary wireless terminals constructed as shown in FIGS. 1 and 2.

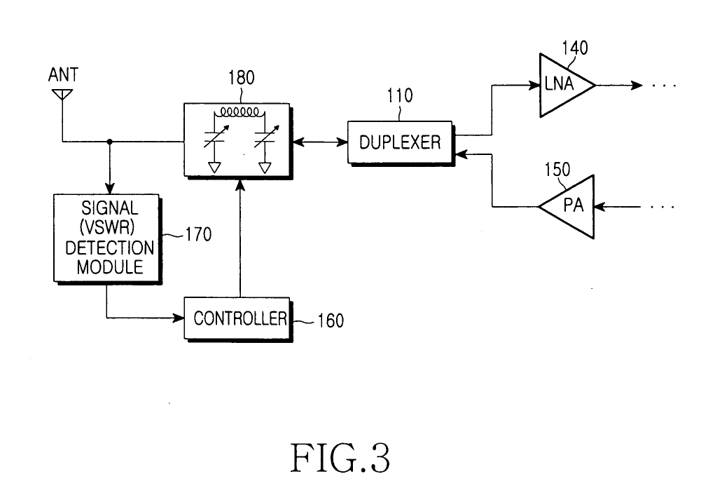

FIG. 3 is a block diagram illustrating a structure of an exemplary apparatus for automatically matching an impedance for a frequency of an antenna in a wireless terminal according to a second embodiment of the present invention.

In the second exemplary embodiment of the present invention, a signal detection module 170 is provided and detects a signal received therein from the antenna ANT and outputs the signal to the controller 160. In detail, the signal detection module 170 comprises a voltage standing wave ratio (VSWR) detection module used for detecting a VSWR signal including a magnitude signal and a phase signal received through the antenna ANT, and then outputting the VSWR signal to the controller 160.

The controller 160 controls the operation of the wireless terminal. If the VSWR signal is output from the signal detection module 170 according to the second exemplary embodiment of the present invention, the controller 160 determines a present state of the wireless terminal according to a type of the received VSWR signal using an automatic matching table. If the present state of the wireless terminal has been determined, the controller 160 extracts the optimum antenna frequency signal value suitable for the automatic impedance matching corresponding to the state of the wireless terminal by using the automatic matching table. Then, the controller 160 controls an automatic matching module 180 according to the optimum antenna frequency signal value suitable for the automatic impedance matching extracted by using the automatic matching table, thereby automatically matching impedance for the antenna frequency.

The automatic matching table can be stored for example, in a memory (not shown) of the wireless terminal in order to store a type of a VSWR signal, a state of a wireless terminal corresponding to the type of the VSWR signal, and the optimum antenna frequency signal value for automatic matching corresponding to the state of the wireless terminal.

The state of the wireless terminal may include “Down Idle Mode (in which a user is not holding the wireless terminal, and a folder of the wireless terminal is closed)”, “Down Held Mode (in which a user holds the wireless terminal, and the folder of the wireless terminal is closed)”, “Open Idle Mode (in which a user is not holding the wireless terminal, and the folder of the wireless terminal is opened)”, and “Open Held Mode (in which a user holds the wireless terminal, and the folder of the wireless terminal is opened)”.

The automatic matching module 180 automatically performs impedance matching for the antenna frequency and comprises a fixed inductor and variable capacitors. After automatically matching impedance for the reception frequency output from the antenna by adjusting values of the capacitors (Cs), the automatic matching module 180 transmits the reception frequency to the first amplifier 140 through a reception port of the duplexer 110. In addition, after the automatic matching module 180 automatically matches impedance for a transmission frequency received therein through a transmission port of the duplexer 110 by adjusting values of the capacitors (Cs), the automatic matching module 180 transmits the transmission frequency to the antenna ANT.

The automatic matching module 180 comprises at least one capacitor bank, in which each capacitor bank comprises n capacitors linked with each other.

FIG. 5 shows an exemplary capacitor bank having n capacitors linked with each other. Values of the capacitors (Cs) included in the capacitor bank may sequentially increase as C/2, C/4, C/8, . . . , and C/2ⁿ. The capacitors are linked through a switch and represent values of “1” and “0” according to an on and off state thereof. In addition, the total capacitance value Cₜₒₜₐₗ of the capacitors equals “0*C/2+1*C/4+0*C/8+ . . . +1*C/2ⁿ”.

According to the second exemplary embodiment of the present invention, it is assumed for example, that the automatic matching module 180 comprises four capacitor banks, in which each capacitor bank comprises eight capacitors (Cs) linked with each other. Thus, according to the second exemplary embodiment of the present invention, one capacitor bank may have 2⁸ (i.e., 256) capacitor values.

Therefore, the automatic matching module 180 performs on/off operations for corresponding capacitors under the control of the controller 160 by extracting capacitor values suitable for forming an optimum transmission/reception frequency signal from a plurality of capacitor (C) values of the four capacitor banks, thereby automatically matching the impedance for the transmission/reception frequency.

The duplexer 10 is divided into a transmission port and a reception port in cooperation with the antenna ANT of the wireless terminal and transmits a reception frequency, which is received through the automatic matching module 180, to the first amplifier 140. In addition, the duplexer 110 transmits a transmission frequency, which is received from the second amplifier 150, to the automatic matching module 180 through the transmission port.

An amplifier module is used for amplifying a frequency signal transmitted/received through the antenna ANT and comprises the first amplifier 140 and the second amplifier 150. The first amplifier 140 amplifies and outputs the reception frequency, which is output from the reception port of the duplexer 110. In this case, the first amplifier 140 may comprise a low noise amplifier (LNA), but is not limited thereto. In addition, the second amplifier 150 amplifies the transmission frequency and outputs the transmission frequency to the transmission port of the duplexer 110. In this case, the second amplifier 150 may comprise a power amplifier (PA), but is not limited thereto.

Hereinafter, an exemplary operation for automatically performing impedance matching for an antenna frequency in a wireless terminal including the exemplary structure shown in FIG. 3 will be described. If a frequency signal is received through the antenna ANT of the wireless terminal, the controller 160 of the wireless terminal detects the frequency signal and outputs the frequency signal received from the antenna to the automatic matching module 180. In this case, the controller 160 determines a state of the wireless terminal based on a signal output from the signal detection module 170, thereby controlling the automatic matching module 180.

If the signal detection module 170 detects a VSWR signal received from the antenna of the wireless terminal and outputs the VSWR signal to the controller 160, the controller 160 determines a state of the wireless terminal corresponding to the VSWR signal received from the signal detection module 170 and extracts the optimum antenna frequency signal value for automatic impedance matching corresponding to the state of the wireless terminal by using the automatic matching table. The controller 160 controls the automatic matching module 180 according to the optimum antenna frequency signal value for the automatic matching, which is extracted by using the automatic matching table, such that impedance matching for the received frequency can be automatically achieved.

The automatic matching module 180 performs on/off operations for corresponding capacitors under the control of the controller 160 by extracting values of capacitor suitable for forming the optimum reception frequency signal from among a plurality of capacitor values, thereby automatically matching the impedance for the reception frequency, and then transmits the reception frequency to the first amplifier 140 through the reception port of the duplexer 110. Then, the controller 160 outputs the reception frequency signal, which has been output from the duplexer 110 with impedance matching, after amplifying the reception frequency signal through the first amplifier 140.

If the transmission frequency signal is generated in the wireless terminal, the transmission frequency signal is detected by the controller 160, amplified in the second amplifier 150, and then output to the automatic matching module 180 through the transmission port of the duplexer 110. In this case, the controller 160 determines a state of the wireless terminal based on a signal output from the signal detection module 170 so as to control the automatic matching module 180.

If the signal detection module 170 detects a VSWR signal received from the antenna of the wireless terminal and outputs the VSWR signal to the controller 160, the controller 160 determines a state of the wireless terminal corresponding to the VSWR signal received from the signal detection module 170 and extracts the optimum antenna frequency signal value for automatic impedance matching corresponding to the state of the wireless terminal by using the automatic matching table. The controller 160 controls the automatic matching module 180 according to the optimum antenna frequency signal value for the automatic impedance matching, which is extracted by using the automatic matching table, such that impedance matching for the transmission frequency can be automatically achieved.

The automatic matching module 180 performs on/off operations for corresponding capacitors under the control of the controller 160 by extracting values of capacitors suitable for forming the optimum transmission frequency signal from a plurality of capacitor values, thereby automatically matching the impedance for the transmission frequency, and then transmits the transmission frequency to the antenna.

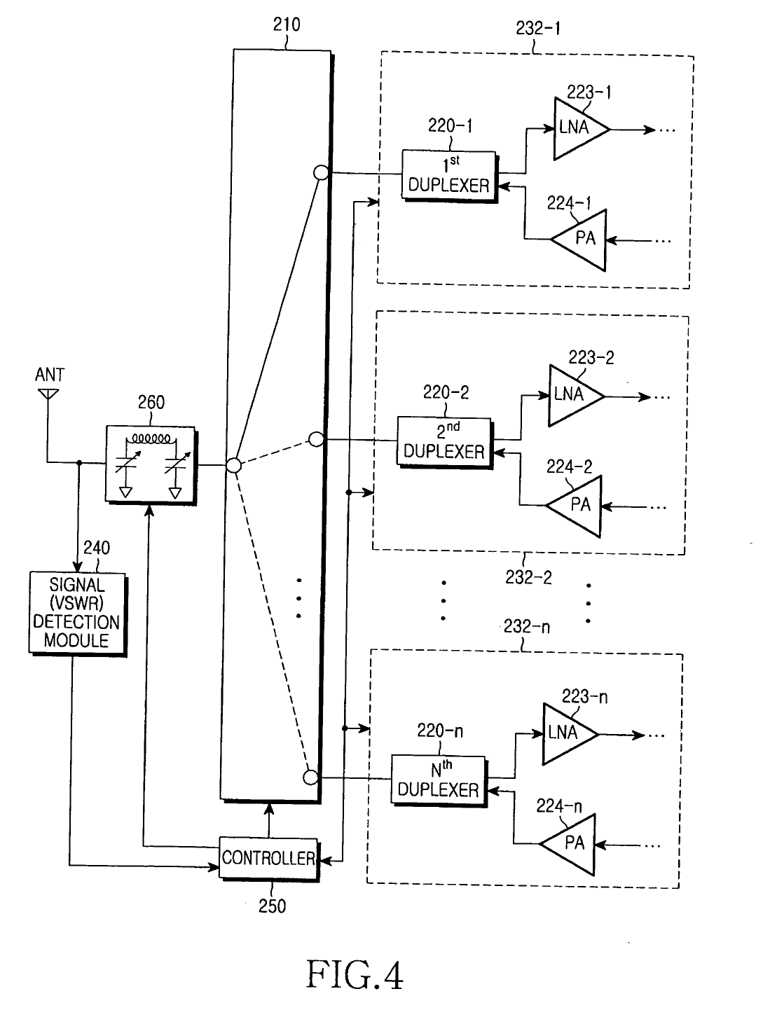

FIG. 4 is a block diagram illustrating another exemplary apparatus for automatically performing impedance matching for an antenna frequency in a wireless terminal receiving at least two communication services according to the second embodiment of the present invention. Herein, the wireless terminal can perform at least two communication services.

In the exemplary apparatus of FIG. 4, a signal detection module 240 is provided and detects a signal received from the antenna ANT and outputs the received signal to the controller 250. The signal detection module 240 comprises a voltage standing wave ratio (VSWR) detection module used for detecting a VSWR signal including a magnitude signal and a phase signal, which is received through the antenna ANT, and then outputting the VSWR signal to the controller 250.

The controller 250 controls the operation of the wireless terminal. The controller 250 controls the switching module 210 to be switched to one of at least two communication services according to the type of a reception signal received in the antenna according to the second exemplary embodiment of the present invention. If a VSWR signal is output from the signal detection module 240 according to the second exemplary embodiment of the present invention, the controller 250 determines a present state of the wireless terminal according to a type of the received VSWR signal by using an automatic matching table. If the present state of the wireless terminal has been determined, the controller 250 extracts the optimum antenna frequency signal value suitable for automatic impedance matching corresponding to the state of the wireless terminal by using the automatic matching table. The controller 250 controls an automatic matching module 260 according to the optimum antenna frequency signal value suitable for the automatic impedance matching, which is extracted by using the automatic matching table, so as to automatically perform impedance matching for the antenna frequency.

The automatic matching table can be stored for example, in a memory (not shown) of the wireless terminal in order to store a type of a VSWR signal, a state of a wireless terminal corresponding to the type of the VSWR signal, and the optimum antenna frequency signal value for automatic impedance matching corresponding to the state of the wireless terminal.

The state of the wireless terminal may be “Down Idle Mode (in which a user is not holding the wireless terminal, and a folder of the wireless terminal is closed)”, “Down Held Mode (in which a user holds the wireless terminal, and the folder of the wireless terminal is closed)”, “Open Idle Mode (in which a user is not holding the wireless terminal, and the folder of the wireless terminal is opened)”, and “Open Held Mode (in which a user holds the wireless terminal, and the folder of the wireless terminal is opened)”.

The automatic matching module 260 automatically performs impedance matching for the antenna frequency under the control of the controller 250 and comprises a fixed inductor and variable capacitors. The automatic matching module 260 automatically performs impedance matching for a transmission/reception frequency of a corresponding communication module linked with the antenna from among at least one communication module by adjusting capacitor (C) values.

The automatic matching module 260 comprises at least one capacitor bank, in which each capacitor bank comprises n capacitors linked with each other as shown in FIG. 5. In addition, the automatic matching module 260 comprises four capacitor banks as in FIG. 3, and each capacitor bank may comprise eight capacitors (Cs) linked with each other.

Therefore, the automatic matching module 260 performs on/off operations for corresponding capacitors under the control of the controller 250 by extracting capacitor values suitable for forming an optimum transmission/reception frequency signal from a plurality of capacitor (C) values of the four capacitor banks, thereby automatically matching the impedance for the transmission/reception frequency of a corresponding communication service module linked with the antenna ANT.

The switching module 210 is switched to one of two or more communication service modules 232-1 to 232-n according to the type of a reception signal received in the antenna ANT of the wireless terminal, such that a communication service corresponding to the communication module, to which the switching module 210 is switched, can be realized.

The two or more communication service modules 232-1 to 232-n perform communication services such as CDMA, PCS, and GSM services, but are not limited thereto. Each of the communication service modules 232-1 to 232-n comprises a duplexer and an amplifier. In addition, the two or more communication service modules 232-1 to 232-n may comprise mobile Internet services, such as wireless LAN or WiBro, in addition to the CDMA, PCS, and GSM services.

Hereinafter, a description will be made in relation to the first communication service module 232-1 from among at least two communication service modules 232-1 to 232-n, but is also applicable to the remaining service modules. As the first duplexer 220-1 is linked with the antenna ANT through the switching module 210, the first duplexer 220-1 is divided into a transmission port and a reception port in cooperation with the antenna ANT. In addition, the first duplexer 220-1 transmits a reception frequency received from the automatic matching module 260 to a first amplifier 223-1. In addition, the first duplexer 220-1 transmits a transmission frequency received from the second amplifier 224-1 to the automatic matching module 260, to which the switching module 210 is switched.

An amplifier module is used for amplifying a frequency signal transmitted/received through the antenna and comprises the first amplifier 223-1 and the second amplifier 224-1. The first amplifier 223-1 amplifies and outputs the reception frequency output from the reception port of the duplexer 110. In this case, the first amplifier 223-1 may comprise a low noise amplifier (LNA), but is not limited thereto. In addition, the second amplifier 224-1 amplifies a transmission frequency and outputs the transmission frequency to the transmission port of the duplexer 110. In this case, the second amplifier 224-1 may comprise a power amplifier (PA), but is not limited thereto.

The second duplexer 220-2 to the n^{th} duplexer 220-n, and amplifiers 223-2 to 223-n and 224-2 to 224-n included in the second communication service module 232-2 to the n^{th} communication service module 232-n, respectively, may perform communication service while performing substantially the same functions as the first duplexer 220-1 and the amplifiers 223-1 and 224-1 included in the first communication service module 232-1.

Hereinafter, an exemplary operational procedure for automatically performing impedance matching for an antenna frequency in a wireless terminal having the exemplary structure shown in FIG. 4 will be described. If a frequency signal for a communication service, which can be performed by the first communication service module, such as a CDMA communication service, is received in the wireless terminal capable of performing two or more communication services, the controller 250 of the wireless terminal detects this and controls the switching module 210 to be switched to the first communication service module 232-1. In this case, the controller 250 controls the automatic matching module 260 by determining a state of the wireless terminal based on a signal output from the signal detection module 240.

If the signal detection module 240 detects a VSWR signal received therein from the antenna ANT of the wireless terminal and outputs the VSWR signal to the controller 250, the controller 250 determines a state of the wireless terminal corresponding to the VSWR signal received from the signal detection module 240 and extracts the optimum antenna frequency signal value for automatic impedance matching corresponding to the state of the wireless terminal by using an automatic matching table. The controller 250 controls the automatic matching module 260 according to the optimum antenna frequency signal value for the automatic impedance matching, which is extracted by using the automatic matching table, such that the impedance matching for the reception frequency can be achieved.

Therefore, the automatic matching module 260 performs on/off operations for corresponding capacitors under the control of the controller 250 by extracting capacitor values suitable for forming an optimum reception frequency signal from a plurality of capacitor (C) values, thereby automatically performing the impedance matching for the reception frequency, and then transmits the reception frequency to the first amplifier 223-1 through the reception port of the first duplexer 220-1 of the first communication service module 232-1, to which the switching module 210 is switched. Thereafter, the controller 250 outputs the reception frequency signal, which has been output from the first duplexer 220-1 with impedance matching, after amplifying the reception frequency signal through the first amplifier 223-1.

If the transmission frequency signal is generated in the first communication service module 232-1, the controller 250 detects the transmission frequency signal, amplifies the transmission frequency signal by means of the second amplifier 224-1, and then outputs the transmission frequency signal to the automatic matching module 260 through the transmission port of the first duplexer 220-1. In this case, the controller 250 determines a state of the wireless terminal based on a signal output from the signal detection module 240 so as to control the automatic matching module 260.

If the signal detection module 240 detects a VSWR signal received from the antenna ANT of the wireless terminal and outputs the VSWR signal to the controller 250, the controller 250 determines a state of the wireless terminal corresponding to the VSWR signal received from the signal detection module 240 and extracts the optimum antenna frequency signal value for automatic impedance matching corresponding to the state of the wireless terminal. The controller 250 controls the automatic matching module 260 according to the optimum antenna frequency for the automatic impedance matching, which is extracted by using the automatic matching table, such that impedance matching for the transmission frequency can be automatically achieved.

The automatic matching module 260 performs on/off operations for corresponding capacitors under the control of the controller 250 by extracting values of capacitors suitable for forming the optimum transmission frequency signal from a plurality of capacitor values, thereby automatically matching the impedance for the transmission frequency, and then transmits the transmission frequency to the antenna ANT.

Although it has been described and shown in FIG. 4 that impedance matching for a transmission/reception frequency of at least one communication service module is achieved by means of one automatic matching module, it is also possible to provide an automatic matching module for each communication service.

Impedance matching for an antenna frequency may be automatically achieved according to the present state of exemplary wireless terminals constructed as shown in FIGS. 3 and 4.

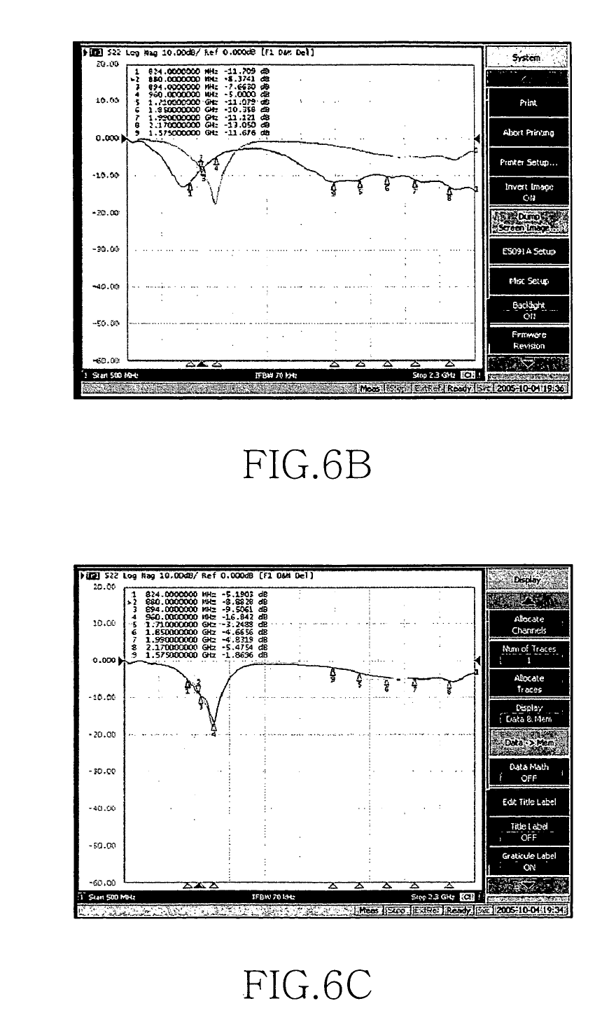

FIGS. 6A to 6C are views for explaining automatic impedance matching for an antenna frequency in a wireless terminal according to embodiments of the present invention.

Conventionally, when the wireless terminal has the “Open Held Mode” as shown in FIG. 6A, in which a user holds the wireless terminal and the folder is opened, impedance matching for an antenna frequency is tilted as shown in the plots of FIG. 6B. However, according to embodiments of the present invention, impedance matching for an antenna frequency is automatically achieved as shown in the plots of FIG. 6C in the wireless terminal having an exemplary structure as shown in any of FIGS. 1 to 4, so it is possible to prevent impedance matching from tilting.

As shown in FIGS. 6B and 6C, x and y axes represent a frequency and a reflection coefficient (γ; gamma), respectively. Herein, the reflection coefficient denotes an index obtained by calculating an amount of reflection caused by an impedance difference on the basis of the ratio of a reflection voltage to an input voltage in a predetermined connection port. In other words, the reflection coefficient denotes an amount of reflection according to an amount of the input. As the reflection coefficient becomes small, the amount of the reflection becomes small. In addition, a plurality of values shown in graphs of FIGS. 6B and 6C represent log scale (dB) values of power corresponding to reflection coefficients at predetermined points marked in the graphs.

As described above, according to embodiments of the present invention, it is possible to prevent the impedance mismatching for an antenna frequency through an apparatus for automatically matching an impedance for the antenna frequency of the wireless terminal even when a user holds the wireless terminal in the user's hand. In addition, it is possible to prevent performance degradation of the wireless terminal due to changes in a voltage standing wave ratio (VSWR) of an antenna and the impedance mismatching of the antenna. Furthermore, embodiments of the present invention can improve both a noise figure of the low noise amplifier (LNA) and the adjacent channel power ratio (ACPR) margin of the power amplifier (PA), and can improve efficiency in a multi-band environment.

While embodiments of the invention have been shown and described with reference to certain exemplary embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. An apparatus for automatically matching impedance for a frequency of an antenna in a wireless terminal, the apparatus comprising:
a duplexer for classifying frequencies transmitted/received through the antenna of the wireless terminal, transmitting a reception frequency, which is received from the antenna, to an automatic matching module, and transmitting a transmission frequency, which is received from the automatic matching module, to the antenna;
the automatic matching module for transmitting the reception frequency, which is received from the duplexer, to an amplifier after automatically matching impedance for the reception frequency and for transmitting the transmission frequency, which is received from the amplifier, to the duplexer after automatically matching impedance for the transmission frequency; and
a controller for controlling the automatic matching module to automatically match impedance for the transmission/reception frequency.

2. The apparatus as claimed in claim 1, wherein the controller is configured to control the automatic matching module to automatically match impedance for the transmission/reception frequency according to a preset antenna frequency signal value.

3. The apparatus as claimed in claim 1, wherein the automatic matching module comprises:
a first automatic matching module, which automatically matches impedance for the reception frequency; and
a second automatic matching module, which automatically matches impedance for the transmission frequency.

4. The apparatus as claimed in claim 1, wherein the automatic matching module comprises a fixed inductor and a variable capacitor.

5. The apparatus as claimed in claim 1, wherein the amplifier comprises:
a first amplifier for amplifying and outputting a signal having the reception frequency, which is received from the automatic matching module; and
a second amplifier for amplifying a signal having the transmission frequency and transmitting the signal to the automatic matching module.

6. An apparatus for automatically matching impedance for a frequency of an antenna in a wireless terminal receiving at least two communication services, the apparatus comprising:
a switching module for switching to one of the at least two communication service modules according to a signal received in an antenna of the wireless terminal; and
at least two communication service modules for outputting a reception frequency, which is received through the antenna, by automatically matching an impedance for the reception frequency, or transmitting a transmission frequency to the antenna by automatically impedance matching the transmission frequency when the communication service modules are linked with the antenna through switching action of the switching module.

7. The apparatus as claimed in claim 6, wherein each of the at least two communication modules comprises:
a duplexer for classifying frequencies transmitted/received through an antenna, transmitting a reception frequency, which is received from the antenna, to an automatic matching module, and transmitting a transmission frequency, which is received from the automatic matching module, to the antenna;
the automatic matching module for transmitting the reception frequency, which is received from the duplexer, to an amplifier after automatically matching an impedance for the reception frequency and for transmitting the transmission frequency, which is received from the amplifier, to the duplexer after automatically matching an impedance for the transmission frequency; and
a controller for controlling the automatic matching module to automatically match an impedance for the transmission/reception frequency.

8. The apparatus as claimed in claim 7, wherein the controller is configured to control the automatic matching module to automatically match an impedance for the transmission/reception frequency according to a preset antenna frequency signal value.

9. The apparatus as claimed in claim 7, wherein the automatic matching module comprises:
a first automatic matching module, which automatically performs impedance matching for the reception frequency; and
a second automatic matching module, which automatically performs impedance matching for the transmission frequency.

10. The apparatus as claimed in claim 7, wherein the automatic matching module comprises a fixed inductor and a variable capacitor.

11. The apparatus as claimed in claim 7, wherein the amplifier comprises:
a first amplifier for amplifying and outputting a signal having the reception frequency, which is received from the automatic matching module; and
a second amplifier for amplifying a signal having the transmission frequency so as to transmit the signal to the automatic matching module.

12. An apparatus for automatically matching impedance for an antenna frequency in a wireless terminal, the apparatus comprising:
a signal detection module for detecting a signal received from an antenna of the wireless terminal;
a controller for determining a state of the wireless terminal according to a signal output from the signal detection module and controlling an automatic matching module to automatically match an impedance for a transmission/reception frequency of the antenna;
the automatic matching module for transmitting the reception frequency, which is received from the antenna, to a duplexer after automatically matching an impedance for the reception frequency, or transmitting the transmission frequency, which is received from the duplexer, to the antenna after automatically matching an impedance for the transmission frequency; and
the duplexer for classifying frequencies transmitted/received through the automatic matching module and transmitting the reception frequency, which is received from the automatic matching module, to the amplifier, or transmitting the transmission frequency, which is received from the amplifier, to the automatic matching module.

13. The apparatus as claimed in claim 12, wherein the signal detection module is configured to detect a voltage standing wave ratio (VSWR) signal comprising a magnitude signal and a phase signal received from the antenna.

14. The apparatus as claimed in claim 12, wherein the controller is configured to:
determine a state of the wireless terminal corresponding to a signal output from the signal detection module through an automatic matching table; and
control the automatic matching module to automatically match an impedance for a transmission/reception frequency of the antenna according to the state of the wireless terminal.

15. The apparatus as claimed in claim 12, wherein the automatic matching module comprises a fixed inductor and a variable capacitor.

16. The apparatus as claimed in claim 12, wherein the amplifier comprises:
a first amplifier, which amplifies and outputs a signal having the reception frequency received from the automatic matching module; and
a second amplifier, which amplifies a signal having the transmission frequency and transmits the signal to the automatic matching module.

17. An apparatus for automatically matching an impedance for an antenna frequency in a wireless terminal, which receives at least two communication services, the apparatus comprising:
a signal detection module for detecting a signal received from an antenna of the wireless terminal;
a controller for determining a state of the wireless terminal according to a signal output from the signal detection module and controlling an automatic matching module to automatically match an impedance for a transmission/reception frequency of the antenna;
the automatic matching module for transmitting the reception frequency which is received from the antenna, to a switching module after automatically matching an impedance for the reception frequency received from the antenna, or for transmitting a transmission frequency, which is received from the switching module, to the antenna after automatically matching an impedance for the transmission frequency;
the switching module for switching a communication path to any one of at least two communication service modules according to a type of a reception signal received in the antenna; and
at least two communication service modules for transmitting/receiving a frequency of the antenna through the automatic matching module if the at least two communication service modules are linked with the automatic matching module through switching action of the switching module.

18. The apparatus as claimed in claim 17, wherein the signal detection module is configured to detect a voltage standing wave ratio (VSWR) signal comprising a magnitude signal and a phase signal received from the antenna.

19. The apparatus as claimed in claim 17, wherein the controller is configured to:
determine a state of the wireless terminal corresponding to a signal output from the signal detection module by using an automatic matching table; and
control the automatic matching module to automatically match impedance for a transmission/reception frequency of the antenna according to the state of the wireless terminal.

20. The apparatus as claimed in claim 17, wherein the controller is configured to control the switching module such that the switching module is switched to any one of at least two communication service modules according to a type of the reception signal received in the antenna.

21. The apparatus as claimed in claim 17, wherein the automatic matching module comprises a fixed inductor and a variable capacitor.

22. The apparatus as claimed in claim 17, wherein each communication service module comprises:
a duplexer for classifying frequencies transmitted/received through the automatic matching module, transmitting the reception frequency received from the automatic matching module to the amplifier, or transmitting a transmission frequency received from the amplifier to the automatic matching module; and
the amplifier for amplifying and outputting a signal having the reception frequency received from the duplexer and amplifying a signal having the transmission frequency to be transmitted to the duplexer.

23. The apparatus as claimed in claim 22, wherein the amplifier comprises:
a first amplifier, which amplifies and outputs a signal having the reception frequency received from the automatic matching module; and
a second amplifier, which amplifies a signal having the transmission frequency and transmits the signal to the automatic matching module.

24. A method for automatically matching impedance for a frequency of an antenna in a wireless terminal, the method comprising:
controlling a duplexer to classify frequencies transmitted/received through the antenna of the wireless terminal and transmit a reception frequency, which is received from the antenna, to an automatic matching module, and transmit a transmission frequency, which is received from the automatic matching module, to the antenna;
controlling the automatic matching module to transmit the reception frequency, which is received from the duplexer, to an amplifier after automatically matching impedance for the reception frequency and transmit the transmission frequency, which is received from the amplifier, to the duplexer after automatically matching impedance for the transmission frequency; and
controlling the automatic matching module to automatically match impedance for the transmission/reception frequency.

25. The method as claimed in claim 24, wherein the step of automatically matching impedance for the transmission/reception frequency is performed according to a preset antenna frequency signal value.

26. The method as claimed in claim 24, further comprising:
automatically matching impedance for the reception frequency using a first automatic matching module; and
automatically matching impedance for the transmission frequency using a second automatic matching module.
